(19) United States
(12) Patent Application Publication
(10) Pub. No.: US 2021/0233293 A1
(43) Pub. Date: Jul. 29, 2021

(54) LOW-DOSE IMAGING METHOD AND APPARATUS

(71) Applicants: OUR UNITED CORPORATION, Xi'an City, Shaanxi (CN); SHENZHEN OUR NEW MEDICAL TECHNOLOGIES DEVELOPMENT CO., LTD., Shenzhen City, Guangdong (CN)

(72) Inventors: Hao Yan, Xi'an City, Shaanxi (CN); Jiuliang LI, Xi'an City, Shaanxi (CN); Yingwen WU, Xi'an City, Shaanxi (CN); Jinsheng LI, Shenzhen City, Guangdong (CN)

(21) Appl. No.: 17/053,061

(22) PCT Filed: May 4, 2018
(86) PCT No.: PCT/CN2018/085628

§ 371 Date: Nov. 4, 2020

(51) Int. Cl. G06T 11/00; G01T 1/17

(52) U.S. Cl. CPC G06T 11/008; G06T 2211/424; G01T 1/17; G06T 11/006

(57) ABSTRACT

Provided is a low-dose imaging method, including continuously acquiring projection data; generating a first image by processing the acquired projection data before a data volume of the acquired projection data reaches a preset volume, and displaying the first image; and generating a second image by processing the preset volume of projection data when the data volume of the acquired projection data reaches the preset volume, and displaying the second image.

The present disclosure is a national phase application based on PCT/CN2018/085628, filed on May 4, 2018, the contents of which are incorporated herein by reference in their entireties.

### TECHNICAL FIELD

The present disclosure relates to the field of image processing, and in particular, to a low-dose imaging method and apparatus.

### BACKGROUND

In clinical and medical imaging diagnosis and radiotherapy, an X-ray computed tomography (CT) technology for diagnosis and a core beam (CB) CT technology for radiotherapy or surgery guidance have been widely applied. However, the excessive X-ray radiation dose during CT and CBCT scanning has impacts on the health of a patient. In order to reduce such adverse impacts, it is possible to reduce the imaging radiation dose to the imaged object while the imaging quality is ensured, data generated by X-ray after passing through a target area of the patient is then captured as projection data, and a target image for clinical treatment is obtained based on the projection data. This mode is also referred to as a low-dose imaging mode. In the low-dose imaging mode, one frame of projection data is acquired each time the radiation is performed.

### SUMMARY

Embodiments of the present disclosure provide a low-dose imaging method and apparatus.

According to a first aspect, a low-dose imaging method is provided. The method includes: continuously acquiring projection data; generating a first image by processing the acquired projection data before a data volume of the acquired projection data reaches a preset volume, and displaying the first image; and generating a second image by processing the preset volume of projection data when the data volume of the acquired projection data reaches the preset volume, and displaying the second image.

Optionally, generating the second image by processing the preset volume of projection data, and displaying the second image includes: generating an i^{th} iteratively reconstructed image by performing an i^{th} iterative reconstruction operation in iterative reconstruction on the preset volume of projection data; and displaying the i^{th} iteratively reconstructed image; wherein i is 1, 2, . . . , m, m being the total number of iterative reconstruction operations in the iterative reconstruction, and m being an integer greater than or equal to 1.

Optionally, displaying the i^{th} iteratively reconstructed image includes displaying the i^{th} iteratively reconstructed image and progress information of generating an m^{th} iteratively reconstructed image.

Optionally, generating the second image by processing the preset volume of projection data, and displaying the second image includes: generating an i^{th} iteratively reconstructed image by performing an i^{th} iterative reconstruction operation in iterative reconstruction on the preset volume of projection data; and generating an i^{th} fused image by fusing i^{th} iteratively reconstructed image and the first image, and displaying the i^{th} fused image, wherein i is 1, 2, . . . , m-1, m being a total number of iterative reconstruction operations in the iterative reconstruction, and m being an integer greater than or equal to 2; generating an m^{th} iteratively reconstructed image by performing an m^{th} iterative reconstruction operation in the iterative reconstruction on the preset volume of projection data, and displaying the m^{th} iteratively reconstructed image.

Optionally, generating the i^{th} fused image by fusing the i^{th} iteratively reconstructed image and the first image includes: determining a weight of a pixel value in the i^{th} iteratively reconstructed image and a weight of a pixel value in the first image according to a number i of iterative reconstruction operations; and generating the i^{th} fused image by fusing the i^{th} iteratively reconstructed image and the first image according to the weight of the pixel value in the i^{th} iteratively reconstructed image and the weight of the pixel value in the first image.

Optionally, displaying the i^{th} iteratively reconstructed image includes displaying the i^{th} iteratively reconstructed image and progress information of generating the m^{th} iteratively reconstructed image.

Optionally, displaying the second image includes displaying the second image and quality information of the second image, wherein the quality information is indicative of image quality of the second image relative to the first image.

According to a second aspect, a low-dose imaging apparatus is provided. The apparatus includes: an acquiring module, configured to continuously acquire projection data; a first processing module, configured to generate a first image by processing the acquired projection data before a data volume of the acquired projection data reaches a preset volume, and display the first image; and a second processing module, configured to generate a second image by processing the preset volume of projection data when the data volume of the acquired projection data reaches the preset volume, and display the second image.

Optionally, the second processing module is configured to generate an i^{th} iteratively reconstructed image by performing an i^{th} iterative reconstruction operation in iterative reconstruction on the preset volume of projection data; and display the i^{th} iteratively reconstructed image; wherein i is 1, 2, . . . , m, m being the total number of iterative reconstruction operations in the iterative reconstruction, and m being an integer greater than or equal to 1.

Optionally, the second processing module is configured to display the i^{th} iteratively reconstructed image and progress information of generating an m^{th} iteratively reconstructed image.

Optionally, the second processing module is configured to: generate an i^{th} iteratively reconstructed image by performing an i^{th} iterative reconstruction operation in iterative reconstruction on the preset volume of projection data; and generate an i^{th} fused image by fusing i^{th} iteratively reconstructed image and the first image, and displaying the i^{th} fused image, wherein i is 1, 2, . . . , m-1, m being a total number of iterative reconstruction operations in the iterative reconstruction, and m being an integer greater than or equal to 2; generate an m^{th} iteratively reconstructed image by performing an m^{th} iterative reconstruction operation in the iterative reconstruction on the preset volume of projection data, and displaying the m^{th} iteratively reconstructed image.

Optionally, the second processing module is configured to determine a weight of a pixel value in the i^{th} iteratively reconstructed image and a weight of a pixel value in the first image according to a number i of iterative reconstruction operations; and generate the i^{th} fused image by fusing the i^{th} iteratively reconstructed image and the first image according to the weight of the pixel value in the i^{th} iteratively reconstructed image and the weight of the pixel value in the first image.

Optionally, the second processing module is configured to display the i^{th} fused image and progress information of generating the m^{th} iteratively reconstructed image.

Optionally, the second processing module is configured to display the second image and quality information of the second image, wherein the quality information is indicative of image quality of the second image compared with the first image.

According to a third aspect, a low-dose imaging apparatus is provided. The apparatus includes: a memory, a processor, and a computer program stored in the memory and executable on the processor, wherein the computer program, when executed by the processor, causes the processor to perform steps in the method according to the first aspect.

According to a fourth aspect, a non-volatile computer-readable storage medium is provided. The computer-readable storage medium stores a computer program, wherein the computer program, when executed by a processor, causes the processor to perform steps in the method according to the first aspect.

According to a fifth aspect, a computer program product is provided. The computer program product stores instructions, wherein the instructions, when executed by a computer, causes the computer to perform the low-dose imaging method according to the first aspect.

According to a sixth aspect, a chip is provided. The chip includes a programmable logic circuit and/or program instructions, wherein the chip, when executed, is caused to perform the low-dose imaging method according to the first aspect.

### BRIEF DESCRIPTION OF THE DRAWINGS

In order to describe the technical solutions in the embodiments of the present disclosure more clearly, the following briefly introduces the accompanying drawings required for describing the embodiments. Apparently, the accompanying drawings as described below show merely some embodiments of the present disclosure, and a person of ordinary skill in the art may also derive other drawings from these accompanying drawings without creative efforts.

FIG. 1 is a flowchart of a low-dose imaging method according to an embodiment of the present disclosure;

FIG. 2 is a flowchart of generating and displaying a first image according to an embodiment of the present disclosure;

FIG. 3 is a flowchart of generating an analytically reconstructed image according to an embodiment of the present disclosure;

FIG. 4 is a flowchart of generating and displaying a second image according to an embodiment of the present disclosure;

FIG. 5 is flowchart of generating and displaying a second image according to an embodiment of the present disclosure;

FIG. 6 is a flowchart of generating a fused image according to an embodiment of the present disclosure;

FIG. 7 is a schematic structural diagram of a low-dose imaging apparatus according to an embodiment of the present disclosure; and

FIG. 8 is a schematic structural diagram of another low-dose imaging device according to an embodiment of the present disclosure.

### DETAILED DESCRIPTION

For clearer descriptions of the objects, technical solutions, and advantages of the present disclosure, the embodiments of the present disclosure are further described in detail in combination with the accompanying drawings. Apparently, the described embodiments are merely some rather than all of the embodiments. All other embodiments obtained by persons of ordinary skill in the art according to the embodiments of the present disclosure without creative efforts shall fall within the protection scope of the present disclosure.

In the related art, in image reconstruction technology, an energy wave such as X-ray, positive electron ray and ultrasonic wave is adopted to irradiate a target area of a patient from various different directions, data generated by the energy wave after passing through the target area of the patient is captured to be as projection data, and the projection data is then calculated by a specific algorithm to reconstruct a tomographic image including the target area of the patient. In the field of image processing, the X-ray CT technology is that X-ray passes through human tissue (for example, internal organs) from different directions, data generated by the X rays after passing through the human tissue is then captured as projection data, and a human tomographic image is then reconstructed based on the projection data. Because the excessive X-ray radiation dose has impact on the health of patients, a low-dose imaging mode relative to a conventional dose imaging mode is provided for reducing the impact on the health of a patient.

Generally, in the conventional dose imaging mode, a human tomographic image is reconstructed by an analytical reconstruction method. The analytical reconstruction method, depending on a continuous signal model, is sensitive to noise and requires complete projection data. For example, the analytical reconstruction method may be a Fourier transform method, a filtered back-projection method or the like. In the low-dose imaging mode, a human tomographic image is reconstructed by an iterative reconstruction method. The iterative reconstruction method depends on a discrete signal model, and in the case of a low signal-to-noise ratio (the signal-to-noise ratio is usually relatively low in the low-dose imaging mode) and incomplete projection data, the human tomographic image with high quality can be reconstructed by the iterative reconstruction method relative to the analytical reconstruction method. For example, the iterative reconstruction method may be an algebra reconstruction technique (ART), ordered subsets expectation maximization (OSEM), a total variation algebra reconstruction technique (TV-ART), maximum a posteriori probability iterative coordinate descent (Maximum A Posteriori reconstruction, MAP-ICD), or the like.

In the low-dose imaging mode, due to low X-ray radiation dose, the quality of each frame of acquired projection data is low. In order to ensure the quality of a target image eventually obtained, iterative reconstruction is usually performed on all frames of projection data after all the frames of projection data have been acquired, so as to generate and display the target image. However, in the process, after waiting for a long time, clinical treatment may only be performed by using an eventual target image. Further, it is necessary to wait until all frames of projection data have been acquired to display the target image, and the time required to display the target image is long, and thus an operator has to unnecessarily waste time for waiting.

In the embodiments of the present disclosure, before a data volume of the acquired projection data reaches a preset volume, first processing may be performed on the acquired projection data, such that a first image is generated and displayed; and when the data volume of the acquired projection data reaches the preset volume, second processing is performed based on the preset volume of projection data, such that a second image is generated and displayed. Compared with the related art, an image can be displayed without waiting until all frames of projection data have been acquired, thus, the time required to display the image is shortened. In this way, abundant reference data is provided for clinical treatment, such that an operator does not need to unnecessarily waste time for waiting.

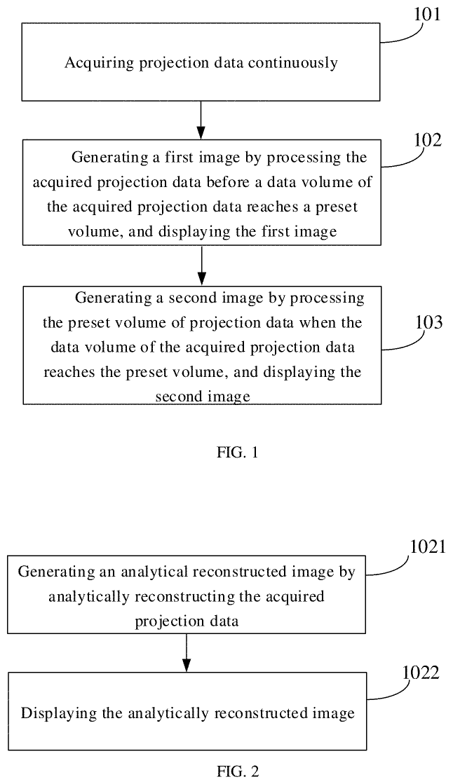

An embodiment of the present disclosure provides a low-dose imaging method, applicable to a low-dose imaging apparatus having a display function in an imaging system. The imaging system may further include an imaging source (for example, a tube). The imaging source emits an energy wave and enables the energy wave to pass through human tissue from different directions. Data generated by the energy wave after passing through the human tissue is captured by an imager (for example, a flat panel detector), and the data is used as projection data. For example, the energy wave may be X-ray, positive electron ray, ultrasonic wave or the like, which is not limited in the embodiments of the present disclosure. The low-dose imaging apparatus acquires the projection data, and processes and displays the projection data by using the low-dose imaging method. As shown in FIG. 1, the low-dose imaging method includes the following steps.

In step 101, projection data is continuously acquired.

In step 102, before a data volume of the acquired projection data reaches a preset volume, a first image is generated by processing the acquired projection data, and the first image is displayed.

In step 103, a second image is generated by processing the preset volume of projection data when the data volume of the acquired projection data reaches the preset volume, and the second image is displayed.

The foregoing low-dose imaging apparatus may be a computer, a server, or the like.

In summary, in the low-dose imaging method according to the embodiments of the present disclosure, projection data can be continuously acquired; before the data volume of the acquired projection data reaches a preset volume, first processing is performed on the acquired projection data, such that a first image is generated and displayed; and when the data volume of the acquired projection data reaches the preset volume, second processing is performed based on the preset volume of projection data, such that a second image is generated and displayed. Compared with the related art, an image can be displayed without waiting until all frames of projection data have been acquired, thus, the time required to display the image is shortened.

In the embodiments of the present disclosure, the first image and the second image may be various types of images. For example, the first image may be an analytically reconstructed image, the second image may be an iteratively reconstructed image, alternatively, the second image may be an image generated after image fusion is performed on the first image and the iteratively reconstructed image. The types of the first image and the second image are not limited in the embodiments of the present disclosure. According to the method, the first image and the second image are generated and displayed during the process of continuous acquisition of projection data. That is, an image can be displayed without waiting until all frames of projection data have been acquired, thus, the time required to display the image is shortened. In this way, abundant reference data is provided for clinical treatment, such that an operator does not need to unnecessarily waste time for waiting.

Optionally, in the step 2 as shown in FIG. 2, generating the first image by processing the acquired projection data, and displaying the first image may include the following steps.

In step 1021, an analytically reconstructed image is generated by analytically reconstructing the acquired projection data.

In step 1022, the analytically reconstructed image is displayed.

It is assumed that the preset volume is 10 frames. Before the data volume of the acquired projection data reaches 10 frames, for example, when three frames of projection data are acquired, an analytically reconstructed image is generated by analytically reconstructing the three frames of acquired projection data, and the analytically reconstructed image is displayed.

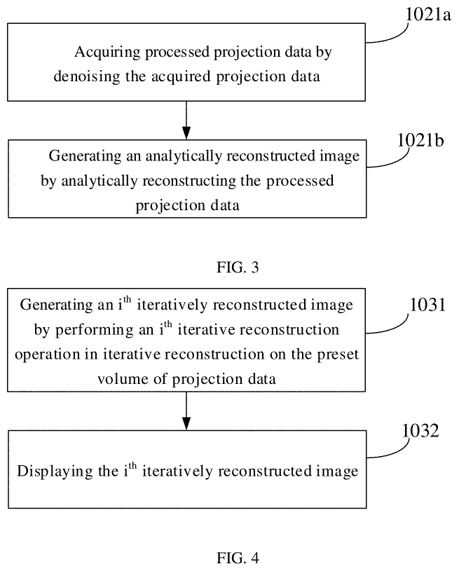

Optionally, during the analytical reconstruction of the acquired projection data, when the acquired projection data does not need to be denoised, the low-dose imaging apparatus may directly perform the analytical reconstruction on the acquired projection data. When the acquired projection data needs to be denoised, the low-dose imaging apparatus may denoise the acquired projection data firstly, and then analytically reconstruct the acquired projection data. Therefore, optionally, as shown in FIG. 3, generating the analytically reconstructed image by analytically reconstructing the acquired projection data may include the following steps.

In step 1021a, processed projection data is acquired by denoising the acquired projection data.

In step 1021b, the analytically reconstructed image is generated by analytically reconstructing the processed projection data.

For example, analytically reconstructing the processed projection data may include: analytically reconstructing the processed projection data by a Fourier transform method or a filtered back-projection method.

After generating the analytically reconstructed image, the low-dose imaging apparatus can display the analytically reconstructed image by a display, so as to provide reference data for clinical treatment. An operator may perform an initial clinical treatment task such as a coarse registration task in image guidance according to the analytically reconstructed image, such that the operator does not need to unnecessarily waste time for waiting.

In step 103, when the data volume of the acquired projection data reaches the preset volume, various ways may be available for generating the second image by processing the preset volume of projection data, and displaying the second image. In an aspect, the processing may be iterative reconstruction, and the generated and displayed second image is an iteratively reconstructed image. In another aspect, the processing may include iterative reconstruction and image fusion, and the generated and displayed second image includes an iteratively reconstructed image and a fused image. Step 103 is described hereinafter by taking the two aspects as an example.

Optionally, in an aspect as shown in FIG. 4, step 103 of generating the second image by processing the preset volume of projection data, and displaying the second image may include the following steps.

In step 1031, an i^{th} iteratively reconstructed image is generated by performing an i^{th} iterative reconstruction operation in iterative reconstruction on the preset volume of projection data.

For example, in this step, the low-dose imaging apparatus may generate the i^{th} iteratively reconstructed image by an ART method, an OSEM method, a TV-ART method or a MAP-ICD method.

In step 1032, the i^{th} iteratively reconstructed image is displayed.

i is 1, 2, . . . , m, wherein m is the total number of iterative reconstruction operations in the iterative reconstruction, and m is an integer greater than or equal to 1.

It is assumed that the preset volume is 10 frames and the total number m of iterative reconstruction operations in the iterative reconstruction is equal to 3, when the low-dose imaging apparatus has acquired 10 frames of projection data, a first iteratively reconstructed image is generated by performing a first iterative reconstruction operation in the iterative reconstruction on the 10 frames of projection data, and is then displayed. A second iteratively reconstructed image is generated by performing a second iterative reconstruction operation in the iterative reconstruction on the 10 frames of projection data, and is then displayed. A third iteratively reconstructed image is generated by performing a third iterative reconstruction operation in the iterative reconstruction on the 10 frames of projection data, and is then displayed.

In the embodiments of the present disclosure, the low-dose imaging apparatus may display the iteratively reconstructed image, such that reference data is provided for clinical treatment, and an operator can fulfill a more detailed clinical treatment task according to the iteratively reconstructed image.

In an optional embodiment, step 1032 of displaying the i^{th} iteratively reconstructed image may include: displaying the i^{th} iteratively reconstructed image and progress information of generating an m^{th} iteratively reconstructed image.

For example, the progress information of generating the m^{th} iteratively reconstructed image may be a time duration from a generation moment of the i^{th} iteratively reconstructed image to a generation moment of the m^{th} iteratively reconstructed image.

It is assumed that the preset volume is 10 frames, and the total number m of iterative reconstruction operations in the iterative reconstruction is equal to 3. In this way, i is equal to 1, 2, and 3 sequentially. When the low-dose imaging apparatus has acquired 10 frames of projection data, the first iterative reconstruction operation in the iterative reconstruction is performed on the 10 frames of projection data, the first iteratively reconstructed image is generated and displayed, and progress information of generating the third iteratively reconstructed image is further displayed. The second iterative reconstruction operation in the iterative reconstruction is performed on the 10 frames of projection data, the second iteratively reconstructed image is generated and displayed, and progress information of generating the third iteratively reconstructed image is further displayed. The third iterative reconstruction operation in the iterative reconstruction is performed on the 10 frames of projection data, the third iteratively reconstructed image is generated and displayed, and progress information of generating the third iteratively reconstructed image is further displayed.

In the embodiments of the present disclosure, the low-dose imaging apparatus displays the i^{th} iteratively reconstructed image and the progress information of generating the m^{th} iteratively reconstructed image, such that an operator can understand the generation progress of the iteratively reconstructed image in time, which facilitates fulfillment of a corresponding clinical treatment task.

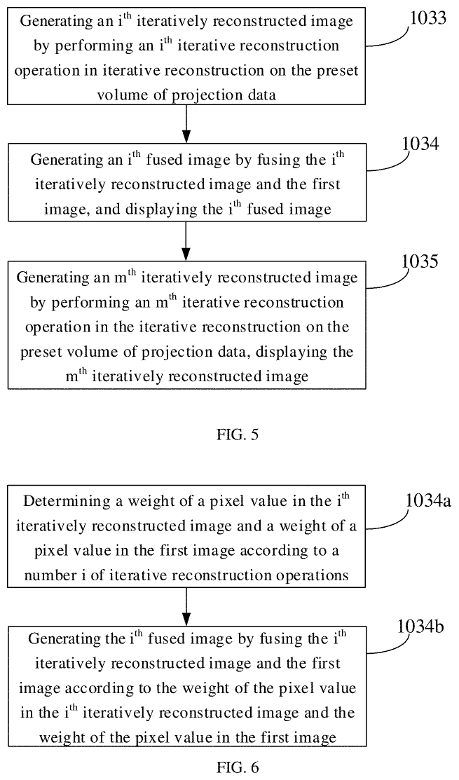

In another aspect as shown in FIG. 5, step 103 of generating the second image by processing the preset volume of projection data, and displaying the second image may include the following steps.

In step 1033, an i^{th} iteratively reconstructed image is generated by performing an i^{th} iterative reconstruction operation in iterative reconstruction on the preset volume of projection data.

In step 1034, an i^{th} fused image is generated by fusing the i^{th} iteratively reconstructed image and the first image, and then displayed.

i is 1, 2, . . . , m-1, wherein m is the total number of iterative reconstruction operations in the iterative reconstruction, and m is an integer greater than or equal to 2.

In step 1035, an m^{th} iteratively reconstructed image is generated by performing an m^{th} iterative reconstruction operation in the iterative reconstruction on the preset volume of projection data, and is then displayed.

It is assumed that the preset volume is 10 frames, and the total number m of iterative reconstruction operations in the iterative reconstruction is equal to 3, and i is equal to 1 and 2 sequentially. When the low-dose imaging apparatus has acquired 10 frames of projection data, a first iteratively reconstructed image is generated by performing a first iterative reconstruction operation in the iterative reconstruction on the 10 frames of projection data, and a first fused image is generated by fusing the first iteratively reconstructed image and the first image and is then displayed. A second iteratively reconstructed image is generated by performing a second iterative reconstruction operation in the iterative reconstruction on the 10 frames of projection data, and a second fused image is generated by fusing the second iteratively reconstructed image and the first image and is then displayed. The low-dose imaging apparatus generates a third iteratively reconstructed image by performing a third iterative reconstruction operation in the iterative reconstruction on the 10 frames of projection data, and then displays the third iteratively reconstructed image.

In the embodiments of the present disclosure, the low-dose imaging apparatus may display the fused image and the m^{th} iteratively reconstructed image, such that reference data is provided for clinical treatment, and an operator may fulfill a corresponding clinical treatment task according to the fused image and the m^{th} iteratively reconstructed image.

For example, the first image for image fusion may be an analytically reconstructed image. As the analytically reconstructed image has higher noise and higher edge information quality, and the iteratively reconstructed image has lower noise and lower edge information quality, in the embodiments of the present disclosure, the low-dose imaging apparatus may generate the i^{th} fused image with lower noise and higher edge information quality by fusing the i^{th} iteratively reconstructed image and the analytically reconstructed image generated in step 1021.

It is assumed that the preset volume is six frames, and the total number m of iterative reconstruction operations in the iterative reconstruction is equal to 3, and i is equal to 1 and 2 sequentially. When three frames of projection data have been acquired, the low-dose imaging apparatus performs analytical reconstruction on the three frames of projection data, and generates an analytically reconstructed image J. When six frames of projection data have been acquired, the low-dose imaging apparatus generates a first iteratively reconstructed image D1 by performing a first iterative reconstruction operation on the six frames of projection data, and further generates a first fused image B1 by fusing the iteratively reconstructed image D1 and the analytically reconstructed image and displays the first fused image B1. The low-dose imaging apparatus generates a second iteratively reconstructed image D2 by performing a second iterative reconstruction operation on the six frames of projection data, and further generates a second fused image B2 by fusing the second iteratively reconstructed image D2 and the analytically reconstructed image J and displays the second fused image B2. The low-dose imaging apparatus then generates a third iteratively reconstructed image D3 by performing a third iterative reconstruction operation on the six frames of projection data and displays the third iteratively reconstructed image D3. In this way, the low-dose imaging apparatus displays a total of two fused images B1 and B2 and one iteratively reconstructed image D3.

In an optional embodiment, step 1034 of displaying the i^{th} fused image may include: displaying the i^{th} fused image and progress information of generating the m^{th} iteratively reconstructed image.

For example, the progress information of generating the m^{th} iteratively reconstructed image may be a time length from a generation moment of the i^{th} fused image to a generation moment of the m^{th} iteratively reconstructed image.

It is assumed that the preset volume is 10 frames, the total number m of iterative reconstruction operations in the iterative reconstruction is equal to 3, and i is equal to 1 and 2 sequentially. When the low-dose imaging apparatus has acquired 10 frames of projection data, a first fused image is generated and displayed, and progress information of generating the third iteratively reconstructed image from the first fused image are further displayed. The low-dose imaging apparatus generates and displays a second fused image, and displays progress information of generating the third iteratively reconstructed image from the second fused image.

In the embodiments of the present disclosure, the low-dose imaging apparatus displays the i^{th} fused image and the progress information of generating the m^{th} iteratively reconstructed image, such that an operator can understand a generation progress of a fused image in time, which facilitates fulfillment of a corresponding clinical treatment task.

Optionally, as shown in FIG. 6, step 1034 of generating the i^{th} fused image by fusing the i^{th} iteratively reconstructed image and the first image may include the following steps:

In step 1034a, a weight of a pixel value (or a pixel) in the i^{th} iteratively reconstructed image and a weight of a pixel value in the first image are determined according to the number i of iterative reconstruction operations.

In step 1034b, the i^{th} fused image is generated by fusing the i^{th} iteratively reconstructed image and the first image according to the weight of the pixel value in the i^{th} iteratively reconstructed image and the weight of the pixel value in the first image.

A sum of the weight of the pixel in the i^{th} iteratively reconstructed image and the weight of the pixel that is in the first image and is to be fused with the pixel is 1. In addition, the weight of the pixel value in the i^{th} iteratively reconstructed image is positively correlated to the number i of iterative reconstruction operations, the weight of the pixel value in the first image is negatively correlated to the number i of iterative reconstruction operations. That is, when the number i of iterative reconstruction operations is larger, the weight of the pixel value in the i^{th} iteratively reconstructed image is larger, and the weight of the pixel value in the first image is smaller. Generally, the pixel in the image may be a pixel corresponding to soft tissue or a pixel corresponding to bone tissue. However, the weight of the pixel value corresponding to soft tissue in the image and the weight of the pixel value corresponding to bone tissue may have different increase or decrease rates and/or modes.

In the embodiments of the present disclosure, when the number i of iterative reconstruction operations increases, the low-dose imaging apparatus may increase the weight of the pixel value in the corresponding i^{th} iteratively reconstructed image, including the weight of the pixel value of the pixel corresponding to soft tissue and the weight of the pixel value of the pixel corresponding to bone tissue. However, the weight of the pixel value of the pixel corresponding to bone tissue and the weight of the pixel value of the pixel corresponding to soft tissue have different increase rates and/or modes. Herein, especially, the weight of the pixel value of the pixel corresponding to bone tissue is increased. In addition, the weight of the pixel value in the first image is reduced, including the weight of the pixel value of the pixel corresponding to soft tissue and the weight of the pixel value of the pixel corresponding to bone tissue. However, the weight of the pixel value of the pixel corresponding to bone tissue and the weight of a pixel value of the pixel corresponding to soft tissue have different decrease rates and/or modes. When the number i of iterative reconstruction operations increases to a preset value, the pixel value in the i^{th} fused image is equal to the pixel value in the i^{th} iteratively reconstructed image. For example, the preset value may be m-1.

For example, when the number i of iterative reconstruction operations is equal to 1, the weight of the pixel value in the first iteratively reconstructed image is q1, and the weight of the pixel value in the first image is p1. When the number i of iterative reconstruction operations is equal to 2, the weight of the pixel value in the second iteratively reconstructed image is q2 and the weight of the pixel value in the first image is p2, wherein q1<q2, and p1>p2.

Optionally, step 103 of displaying the second image may include: displaying the second image and quality information of the second image, wherein the quality information is indicative of image quality of the second image relative to the first image.

In the embodiments of the present disclosure, in addition to displaying the second image, the low-dose imaging apparatus may further display the quality information of the second image, and the low-dose imaging apparatus may determine the quality information of the second image by an image quality assessment. In this way, an operator can understand the quality of the second image in time, and further determine a clinical treatment task for which the second image may be used in clinical treatment, such that the operator does not need to unnecessarily waste time for waiting.

Optionally, the image quality assessment may be an objective assessment of digital image quality. For example, the objective assessment of digital image quality may be a full reference (FR) type, a reduced reference (RR) type or a no reference (NR) type. In the FR, an original image is known, and the quality of a current image is assessed based on the original image. In the NR, no original image is present, the quality of the entire image is predicted based on a local feature of a discernible image in a current image. The RR is a manner between the FR and the NR. In the RR, the quality of a current image is assessed by using partial information of the original image. The original image is the first image in the embodiments of the present disclosure, and the current image is the second image in the embodiments of the present disclosure. For example, the first image may be an analytically reconstructed image, and the second image may be an iteratively reconstructed image.

Alternatively, the second image may be a fused image.

In addition, the image quality assessment manner may be alternatively a subjective test assessment manner. In the subjective test assessment manner, two images are provided to a viewer under a particular condition (an image source, a display, a viewing condition or the like). The two images are the second image and the first image in the embodiments of the present disclosure. The viewer identifies a large amount of score data according to the second image and the first image, and acquires statistics of the large amount of score data, to further obtain the quality information of the second image. For example, the score data may include data such as average values and standard deviations. In the subjective test assessment manner, the quality information of the second image may have two representation forms. One representation form is an absolute score representation form, that is, the absolute quality of the second image is represented. The other representation form is a difference value representation form, that is, an absolute difference between assessment results of the second image and the first image is represented.

It needs to be noted that the sequence of the steps in the low-dose imaging method according to the embodiments of the present disclosure may be appropriately adjusted, and the steps of the low-dose imaging method may be added or reduced as required. Any variant method that may be readily figured out by a person skilled in the art within the technical scope disclosed in the present disclosure shall fall within the protection scope of the present disclosure. Therefore, details are not described again.

In summary, in the low-dose imaging method according to the embodiments of the present disclosure, projection data can be continuously acquired; before the data volume of the acquired projection data reaches a preset volume, first processing is performed on the acquired projection data, such that a first image is generated and displayed; and when the data volume of the acquired projection data reaches the preset volume, second processing is performed based on the preset volume of projection data, such that a second image is generated and displayed. Further, progress information of the second image and quality information of the second image can further be displayed. Compared with the related art, an image can be displayed without waiting until all frames of projection data have been acquired, thus, the time required to display the image is shortened, and reference data is provided for clinical treatment.

An embodiment of the present disclosure provides a low-dose imaging apparatus. The low-dose imaging apparatus has a display function and is disposed in an imaging system.

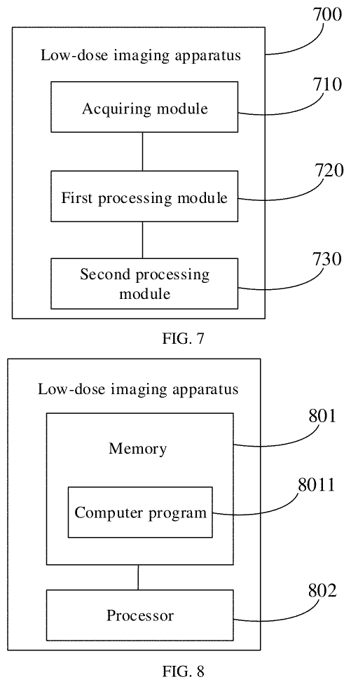

As shown in FIG. 7, the apparatus 700 includes: an acquiring module 710, configured to acquire projection data continuously; a first processing module 720, configured to generate a first image by processing the acquired projection data before a data volume of the acquired projection data reaches a preset volume, and display the first image; and a second processing module 730, configured to generate a second image by processing on the preset volume of projection data when the data volume of the acquired projection data reaches the preset volume, and display the second image.

In summary, in the low-dose imaging apparatus according to the embodiments of the present disclosure, the acquisition module continuously acquires projection data; the first processing module performs first processing on the acquired projection data before the data volume of the acquired projection data reaches a preset volume, such that a first image is generated and displayed; and the second processing module performs second processing on the preset volume of projection data when the data volume of the acquired projection data reaches the preset volume, such that a second image is generated and displayed. Compared with the related art, an image can be displayed without waiting until all frames of projection data have been acquired. Thus, the time required to display the image is shortened.

Optionally, the first processing module 720 is configured to generate an analytically reconstructed image by analytically reconstructing the acquired projection data; and display the analytically reconstructed image.

Optionally, the second processing module 730 is configured to generate an i^{th} iteratively reconstructed image by performing an i^{th} iterative reconstruction operation in iterative reconstruction on the preset volume of projection data; and display the i^{th} iteratively reconstructed image; wherein i is 1, 2, . . . , m, m being the total number of iterative reconstruction operations in the iterative reconstruction, and m being an integer greater than or equal to 1.

Optionally, the second processing module 730 is configured to display the i^{th} iteratively reconstructed image and progress information of generating an m^{th} iteratively reconstructed image.

Optionally, the second processing module 730 is configured to: generate an i^{th} iteratively reconstructed image by performing an i^{th} iterative reconstruction operation in iterative reconstruction on the preset volume of projection data; generate an i^{th} fused image by fusing the i^{th} iteratively reconstructed image and the first image, and display the i^{th} fused image, wherein i is 1, 2, . . . , m-1, m being the total number of iterative reconstruction operations in the iterative reconstruction, and m being an integer greater than or equal to 2; and generate an m^{th} iteratively reconstructed image by performing an m^{th} iterative reconstruction operation in the iterative reconstruction on the preset volume of projection data, and display the m^{th} iteratively reconstructed image.

Optionally, the second processing module 730 is configured to determine a weight of a pixel value in the i^{th} iteratively reconstructed image and a weight of a pixel value in the first image according to a number i of iterative reconstruction operations; and generate the i^{th} fused image by fusing the i^{th} iteratively reconstructed image and the first image according to the weight of a pixel value in the i^{th} iteratively reconstructed image and the weight of a pixel value in the first image.

Optionally, the second processing module 730 is configured to display the i^{th} fused image and progress information of generating the m^{th} iteratively reconstructed image.

Optionally, the second processing module 730 is configured to display the second image and quality information of the second image, wherein the quality information is indicative of image quality of the second image relative to the first image.

In summary, in the low-dose imaging apparatus according to the embodiments of the present disclosure, the acquisition module continuously acquires projection data; the first processing module performs first processing on the acquired projection data before the data volume of the acquired projection data reaches a preset volume, such that a first image is generated and displayed; and the second processing module performs second processing on the preset volume of projection data when the data volume of the acquired projection data reaches the preset volume, such that a second image is generated and displayed. Compared with the related art, an image can be displayed without waiting until all frames of projection data have been acquired. Thus, the time required to display the image is shortened.

It may be clearly understood by a person skilled in the art that, for the purpose of convenient and brief description, the detailed working process of the foregoing apparatuses and modules may refer to a corresponding process in the foregoing method embodiments, and details are not described herein again.

An embodiment of the present disclosure further provides a low-dose imaging device. As shown in FIG. 8, the device includes: a memory 801, a processor 802, and a computer program 8011 stored in the memory 801 and executable on the processor 802, wherein the computer program 8011, when executed by the processor 802, causes the processor 802 to perform steps in the low-dose imaging method according to the foregoing embodiments.

In summary, in the low-dose imaging apparatus according to the embodiments of the present disclosure, projection data can be continuously acquired; before the data volume of the acquired projection data reaches a preset volume, the acquired projection data is processed such that a first image is generated and displayed; and when the data volume of the acquired projection data reaches the preset volume, the preset volume of projection data is processed such that a second image is generated and displayed. Further, progress information of the second image and quality information of the second image can be displayed. Compared with the related art, an image can be displayed without waiting until all frames of projection data have been acquired. Thus, the time required to display the image is shortened, and reference data is provided for clinical treatment.

An embodiment of the present disclosure further provides a computer-readable storage medium. The storage medium is a non-volatile readable storage medium, and the computer-readable storage medium stores a computer program, wherein the computer program, when executed by a processor, causes the processor to perform the steps in the low-dose imaging method according to the foregoing embodiments.

An embodiment of the present disclosure further provides a computer program product. The computer program product stores instructions, wherein the instructions, when executed by a computer, causes the computer to perform the steps in the low-dose imaging method according to the foregoing embodiments.

An embodiment of the present disclosure further provides a chip. The chip includes a programmable logic circuit and/or program instructions, wherein the chip, when executed, is caused to perform the steps in the low-dose imaging method according to the foregoing embodiments.

A person of ordinary skill in the art may understand that all or some of the steps of the embodiments may be implemented by hardware or a program instructing relevant hardware. The program may be stored in a computer-readable storage medium. The storage medium may be a read-only memory, a magnetic disk, an optical disk, or the like.

Described above are merely example embodiments of the present disclosure but are not used to limit the present disclosure. Any changes, equivalent replacements, and improvements made within the spirit and principle of the present disclosure shall fall within the protection scope of the present disclosure.

1. A low-dose imaging method, comprising:
continuously acquiring projection data;
generating a first image by processing the acquired projection data before a data volume of the acquired projection data reaches a preset volume, and displaying the first image; and
generating a second image by processing the preset volume of the projection data in response to the data volume of the acquired projection data reaching the preset volume, and displaying the second image.

2. The method according to claim 1, wherein said generating the second image by said processing the preset volume of the projection data, and said displaying the second image comprise:
generating an i^{th} iteratively reconstructed image by performing an i^{th} iterative reconstruction operation in an iterative reconstruction on the preset volume of the projection data; and
displaying the i^{th} iteratively reconstructed image, wherein i is at least one of 1, 2, . . . , or m, m being a total number of iterative reconstruction operations in the iterative reconstruction, and an integer greater than or equal to 1.

3. The method according to claim 2, wherein said displaying the i^{th} iteratively reconstructed image comprises:
displaying the i^{th} iteratively reconstructed image and progress information of generating an m^{th} iteratively reconstructed image.

4. The method according to claim 1, wherein said generating the second image by said processing the preset volume of the projection data, and said displaying the second image comprise:
generating an i^{th} iteratively reconstructed image by performing an i^{th} iterative reconstruction operation in an iterative reconstruction on the preset volume of the projection data;
generating an i^{th} fused image by fusing the i^{th} iteratively reconstructed image and the first image, and displaying the i^{th} fused image, wherein i is at least one of 1, 2, . . . , or m-1, m being a total number of iterative reconstruction operations in the iterative reconstruction, and an integer greater than or equal to 2; and
generating an m^{th} iteratively reconstructed image by performing an m^{th} iterative reconstruction operation in the iterative reconstruction on the preset volume of the projection data, and displaying the m^{th} iteratively reconstructed image.

5. The method according to claim 4, wherein said generating the i^{th} fused image by said fusing the i^{th} iteratively reconstructed image and the first image comprises:
determining a weight of a pixel value in the i^{th} iteratively reconstructed image and a weight of a pixel value in the first image according to a number i of the iterative reconstruction operations; and
generating the i^{th} fused image by fusing the i^{th} iteratively reconstructed image and the first image according to the weight of the pixel value in the i^{th} iteratively reconstructed image and the weight of the pixel value in the first image.

6. The method according to claim 5, wherein said displaying the i^{th} fused image comprises:
displaying the i^{th} fused image and progress information of said generating the m^{th} iteratively reconstructed image.

7. The method according to claim 1, wherein said displaying the second image comprises:
displaying the second image and quality information of the second image, wherein the quality information is indicative of image quality of the second image relative to the first image.

8. (canceled)

9. A low-dose imaging apparatus, comprising:
a memory, a processor, and a computer program stored in the memory and executable by the processor, wherein the computer program, when executed by the processor, causes the processor to perform a low-dose imaging method comprising:
continuously acquiring projection data;
generating a first image by processing the acquired projection data before a data volume of the acquired projection data reaches a preset volume, and displaying the first image; and
generating a second image by processing the preset volume of the projection data in response to the data volume of the acquired projection data reaching the preset volume, and displaying the second image.

10. A non-volatile computer-readable storage medium storing a computer program thereon, wherein the computer program, when executed by a processor, causes the processor to perform a low-dose imaging method comprising:
continuously acquiring projection data;
generating a first image by processing the acquired projection data before a data volume of the acquired projection data reaches a preset volume, and displaying the first image; and
generating a second image by processing the preset volume of the projection data in response to the data volume of the acquired projection data reaching the preset volume, and displaying the second image.

11. The storage medium according to claim 10, wherein said generating the second image by said processing the preset volume of the projection data, and said displaying the second image comprise:
generating an i^{th} iteratively reconstructed image by performing an i^{th} iterative reconstruction operation in an iterative reconstruction on the preset volume of the projection data; and
displaying the i^{th} iteratively reconstructed image, wherein i is at least one of 1, 2, . . . , or m, m being a total number of iterative reconstruction operations in the iterative reconstruction, and an integer greater than or equal to 1.

12. The storage medium according to claim 10, wherein said generating the second image by said processing the preset volume of the projection data, and said displaying the second image comprise:
generating an i^{th} iteratively reconstructed image by performing an i^{th} iterative reconstruction operation in an iterative reconstruction on the preset volume of the projection data;
generating an i^{th} fused image by fusing the i^{th} iteratively reconstructed image and the first image, and displaying the i^{th} fused image, wherein i is at least one of 1, 2, . . . , or m-1, m being a total number of iterative reconstruction operations in the iterative reconstruction, and an integer greater than or equal to 2; and
generating an m^{th} iteratively reconstructed image by performing an m^{th} iterative reconstruction operation in the iterative reconstruction on the preset volume of the projection data, and displaying the m^{th} iteratively reconstructed image.

13. A computer program product storing instructions thereon, wherein the instructions, when executed by a computer, causes the computer to perform the low-dose imaging method as defined in claim 1.

14. A chip, comprising a programmable logic circuit, wherein the chip, when executed, is caused to perform the low-dose imaging method as defined in claim 1.

15. A chip, comprising program instructions, wherein the chip, when executed, is caused to perform the low-dose imaging method as defined in claim 1.

16. The apparatus according to claim 9, wherein said generating the second image by said processing the preset volume of the projection data, and said displaying the second image comprise:
generating an i^{th} iteratively reconstructed image by performing an i^{th} iterative reconstruction operation in an iterative reconstruction on the preset volume of the projection data; and
displaying the i^{th} iteratively reconstructed image, wherein i is at least one of 1, 2, . . . , or m, m being a total number of iterative reconstruction operations in the iterative reconstruction, and an integer greater than or equal to 1.

17. The apparatus according to claim 16, wherein said displaying the i^{th} iteratively reconstructed image comprises:
displaying the i^{th} iteratively reconstructed image and progress information of generating an m^{th} iteratively reconstructed image.

18. The apparatus according to claim 9, wherein said generating the second image by said processing the preset volume of the projection data, and said displaying the second image comprise:
generating an i^{th} iteratively reconstructed image by performing an i^{th} iterative reconstruction operation in an iterative reconstruction on the preset volume of the projection data;
generating an i^{th} fused image by fusing the i^{th} iteratively reconstructed image and the first image, and displaying the i^{th} fused image, wherein i is at least one of 1, 2, . . . , or m-1, m being a total number of iterative reconstruction operations in the iterative reconstruction, and an integer greater than or equal to 2; and
generating an m^{th} iteratively reconstructed image by performing an m^{th} iterative reconstruction operation in the iterative reconstruction on the preset volume of the projection data, and displaying the m^{th} iteratively reconstructed image.

19. The apparatus according to claim 18, wherein said generating the i^{th} fused image by said fusing the i^{th} iteratively reconstructed image and the first image comprises:
determining a weight of a pixel value in the i^{th} iteratively reconstructed image and a weight of a pixel value in the first image according to a number i of the iterative reconstruction operations; and
generating the i^{th} fused image by fusing the i^{th} iteratively reconstructed image and the first image according to the weight of the pixel value in the i^{th} iteratively reconstructed image and the weight of the pixel value in the first image.

20. The apparatus according to claim 19, wherein said displaying the i^{th} fused image comprises:
displaying the i^{th} fused image and progress information of said generating the m^{th} iteratively reconstructed image.

21. The apparatus according to claim 9, wherein said displaying the second image comprises:
displaying the second image and quality information of the second image, wherein the quality information is indicative of image quality of the second image relative to the first image.
